(19) United States
(12) Patent Application Publication
(10) Pub. No.: US 2009/0095278 A1
(43) Pub. Date: Apr. 16, 2009

(54) Cooking Appliance

(75) Inventors: Ingo Bally, Traunstein (DE); Alexander Dinkel, Unterwoessen (DE); Kerstin Feldmann, Bretten (DE); Wolfgang Fuchs, Altenmarkt a.d. Alz (DE); Martin Keller, Traunreut (DE); Edmund Kuttalek, Grassau (DE); Maximilian Neuhauser, Chieming/Egerer (DE); Klemens Roch, Trostberg (DE); Wolfgang Schnell, Trostberg (DE); Guenter Zschau, Traunwalchen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeraete GmbH, Muenchen (DE)

(21) Appl. No.: 12/087,957

(22) PCT Filed: Jan. 3, 2007
(86) PCT No.: PCT/EP2007/050023

§ 371 Date: Jul. 18, 2008

(30) Foreign Application Priority Data
Jan. 31, 2006 (DE) 10 2006 004 380.4

(51) Int. Cl. F24C 15/00; H05B 6/66

(52) U.S. Cl. 126/273 R; 219/702

(57) ABSTRACT

A cooking appliance, especially a built-in wall cooking appliance, which comprises at least one muffle, delimiting a cooking compartment and having a muffle opening, a door, guided by a lift mechanism, for closing the muffle opening, and at least one switch that switches dependent on a position of the door. The invention is characterized in that the switch is switched by the lift mechanism.

The present invention relates to a cooking appliance, in particular a built-in high-level cooking appliance, with a muffle delimiting a cooking chamber and having a muffle opening, a door for closing said muffle opening, said door being guided by a lift mechanism, and with at least one switch which operates depending on a door position. The present invention also relates to an associated operating method.

DE 102 28 140 A1 and DE 102 28 141 A1 disclose generic built-in high-level cooking appliances wherein the raising of a base door onto a muffle frame actuates a switch mounted on the lower muffle frame, causing a drive unit to be deactivated. The disadvantage of this is that the switches have high switching point tolerances, which means that correct closing of the base door is not guaranteed. The tolerances are due in part to the heat insulation of the switches, particularly if the switch is mounted on or close to the base door. Seals also can produce increased switching inaccuracy. In addition, switching inaccuracies can arise due to tilted or misaligned base doors, possibly resulting in incorrect operation of the cooking appliance, e.g. heating-up of the muffle when the base door is still slightly open.

The object of the present invention is to provide a cooking appliance with more reliable travel-dependent switching.

This object is achieved by the cooking appliance having the features set forth in claim 1 and by a method as claimed in claim 12. Advantageous embodiments are recited in particular in the dependent claims, either individually or in combination.

To this end, the cooking appliance, which is in particular a built-in high-level cooking appliance but can also be a cooking appliance with an oven carriage, is designed such that the switch is operated by the lift mechanism. This means that the switch is unaffected by tilting of the door (e.g. by its own weight) and can also be disposed at non-critical locations in terms of exposure to heat. Consequently, the switch no longer needs to be thermally insulated and its operation is also no longer affected by any seal.

It is then particularly advantageous if the switch is located well away from the muffle opening, in particular above the muffle. For precise switching influenced as little as possible by deflections or elastic effects of the lift mechanism, particularly in the case of a built-in high-level cooking appliance, the switch is disposed above the lift mechanism. For precise switching it is also advantageous if the lift mechanism can be moved linearly, particularly on the basis of a telescopic rail, e.g. a double telescopic rail. The switch can then be operated e.g. by a rail section that moves relative to the switch, e.g. by the runner guide (‘C-rail’) of the runner or elements emerging therefrom.

To use the switch as a limit switch it is advantageous if the switch operates when the lift mechanism has reached a position corresponding to the closing zero position of the door, e.g. when the runner guide or the runner of the telescopic rail has been drawn up or rather moved together to an appropriate position (e.g. height).

To determine a particular end zone or rather gap dimension (dend) it can also be advantageous if the switch operates when the lift mechanism has reached a position corresponding to a predetermined distance of the door from the closing zero position P0.

For increased operating reliability or to detect trapping, the switch is designed redundantly, e.g. as two switches.

The presence of the actuating signals of the at least one switch is preferably a necessary but insufficient condition for ascertaining the zero position, i.e. closing position, of the door.

It is additionally advantageous if a zero position is ascertained when the at least one switch is actuated and, simultaneously, a door travel measurement indicates attainment of a zero position P0 at least within a defined tolerance range, e.g. ±1%. The travel can then also be reset to a predetermined zero point value. Thus, for example, ‘swallowing up’ of sensor pulses within a tolerance range can be compensated.

It is meteorologically advantageous here if the door travel is determined by measuring a number of revolutions of the motor or of an associated gear or a fraction of this number, it being particularly advantageous if at least one sensor unit, in particular a Hall effect sensor unit, is present and connected to the control unit in order to measure an rpm of a motor shaft or a fraction thereof. It is then further advantageous if the control unit, starting from an initial zero position, counts the sensor pulses transmitted by the sensor unit as the door moves and converts them into a distance traveled.

Other conditions can additionally or alternatively be used to ascertain the zero point position. For example, it can be advantageous if a zero position P0 is ascertained when the at least one switch is actuated and, at the same time, with the drive device activated, the door cannot be moved any further. This condition can come into play additionally or alternatively to the measured travel distance condition. The stopping of the base door or rather of the drive device can be determined in any manner, e.g. by measuring the motor or gear speed, direct measurement of the travel velocity of the base door, motor output or motor current, etc.

The at least one switch can advantageously be two switches which are mounted in particular on either side of the cooking appliance, the presence of the actuating signals of the two switches being a necessary but insufficient condition for determining the zero position.

To avoid deterioration of the switching tolerance, the at least one switch is preferably attached to the body and is actuated by the lifting element, in particular by a telescopic rail.

It is particularly advantageous if, to determine a zero position P0 of a door of a cooking appliance, the zero position of the door is ascertained—typically by the control circuit—when simultaneously
(a) the at least one switch has been actuated and
(b1) it has been measured that a travel distance of the door corresponds to the zero position P0 at least within a tolerance range (e.g. ±2 sensor pulses or ±0.1 cm) and/or
(b2) with the drive device activated, the door cannot be moved any further.

If condition (a) and at least one of conditions (b1) and (b2)—or another condition for determining the zero point position P0 are present, this position is fixed or rather initialized as the new zero position P0.

However, the travel does not need to have a tolerance range, but can also be to be fulfilled as a precise condition, e.g. the Hall effect pulse counter must then correspond exactly to the value for the zero point position.

It is particularly advantageous if, at least when condition (a) occurs and at least one of the other conditions (b1, b1) used for determining the zero position P0 does not occur, or when condition (a) does not occur, but all the other conditions (b1, b1) used for determining the zero position (P0) occur, an error is determined or rather an associated error routine is run which can include e.g. reversing the door.

The actuating signals of the switches can be of any kind, e.g. comprise a high or a low level.

In one embodiment of the cooking appliance, two helical cables are provided, each of which is fastened unilaterally on one side of the door, the helical cables being guided through an insert molding to a drive wheel of a drive motor, whereby they are linked to a motor shaft on opposite sides. Rotation of the drive wheel causes the helical cables to be displaced linearly in opposite directions, the door being displaced linearly accordingly. The advantage of using the helical cable drive in the cooking appliance is first that it makes for a space-saving design, as the cable drum otherwise present on the drive motor is no longer required. Secondly, installation and adjustment are much simpler compared to a cable drum drive, as time-consuming winding onto the cable drum, requiring e.g. a cable tensioner, is dispensed with. The fact that the helical cables are connected to the door generally means that they can be attached to the door directly or to an element connected to the door, such as a telescopic bar.

For increased operating reliability it is advantageous if each switching device is connected to a control circuit which is set up such that it detects trapping by evaluating the signals of the switching devices.

The invention can be used particularly advantageously in a built-in high-level cooking appliance with a bottom muffle opening and a base door.

The invention will now be described in greater detail with reference to the embodiments shown in the accompanying schematic drawings, these embodiments not limiting the scope of the invention. In these drawings:

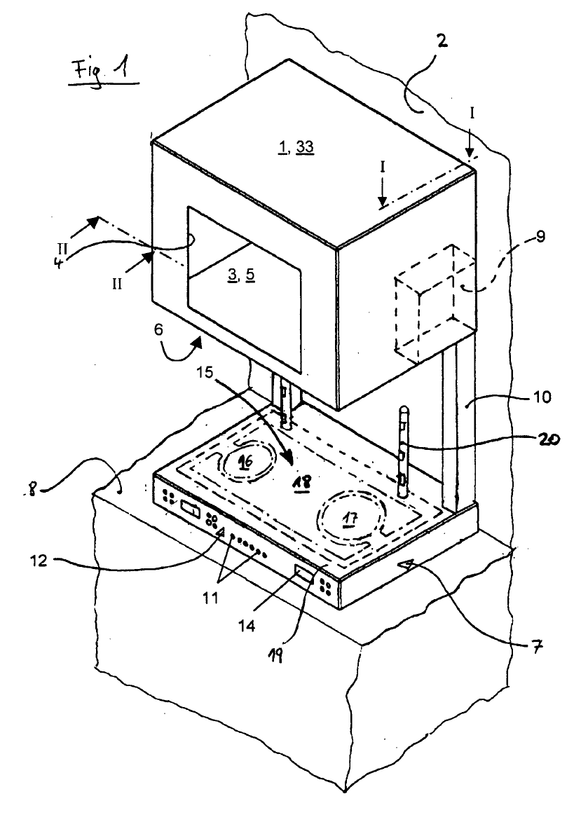

FIG. 1 shows a perspective view of a wall-mounted built-in high-level cooking appliance with the base door lowered;

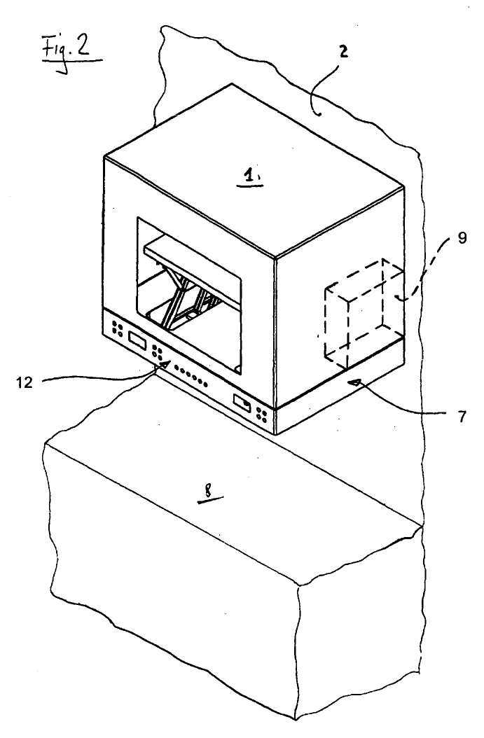

FIG. 2 shows a perspective view of the built-in high-level cooking appliance with the base door closed;

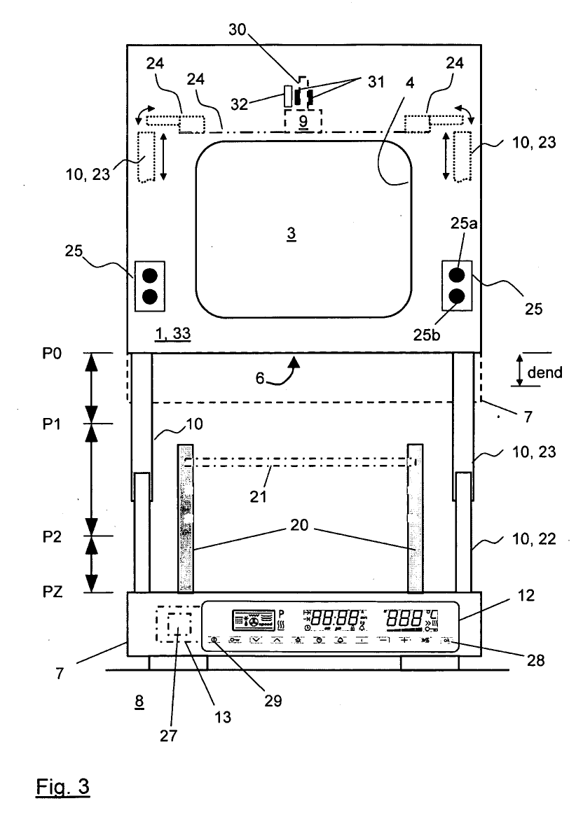

FIG. 3 shows a front view of another embodiment of a built-in high-level cooking appliance.

To better illustrate the individual elements, the figures are not necessarily drawn to scale.

FIG. 1 shows a built-in high-level cooking appliance with a housing 1. The back of the housing 1 is mounted to a wall 2 in the manner of a suspended cabinet. The housing 1 defines a cooking chamber 3 which can be inspected through a viewing window 4 provided on the front of the housing 1. It can be seen from FIG. 3 that the cooking chamber 3 is bounded by a muffle 5 which is provided with heat-insulating cladding (not shown), and that the muffle 5 has a bottom muffle opening 6. The muffle opening 6 can be closed with a base door 7. In FIG. 1 the base door 7 is shown lowered, with its underside resting on a countertop 8 of a kitchen unit. To close the cooking chamber 3, the base door 7 must be moved to the position shown in FIG. 2, termed the “zero position”. To move the base door 7, the built-in high-level cooking appliance has a drive device 9, 10. The drive device 9, 10 has a drive motor 9 represented by dashed lines which is disposed between the muffle 5 and an outer wall of the housing 1. The drive motor 9 is disposed in the region of the back of the housing 1 and, as shown in FIG. 1 or 3, is operatively connected to a pair of lifting elements 10 which are connected to the base door 7. As shown in the schematic side view in FIG. 3, each lifting element 10 is implemented as a telescopic bar which is mounted, for example, on one side of the base door 7 (e.g. on a supporting bracket projecting from the upper side of the base door 7). To move the base door 7, the drive motor 9 can be actuated using an operator panel 12 and a control circuit 13, said operator panel being disposed on the front of the base door 7 as illustrated in FIGS. 1 and 2. As shown in FIG. 3, the control circuit 13 is located behind the operator panel 12 inside the base door 7. The control circuit 13, which here comprises a plurality of physically and functionally separate circuit boards communicating via a communications bus, constitutes a central control unit for appliance operation and controls in an open and/or closed loop manner e.g. heating, movement of the base door 3, implementation of user inputs, lighting, anti-trap protection, cycling of the heating elements 16, 17, 18, 22 and much more besides.

FIG. 1 shows that the upper side of the base door 7 has a cooktop 15. Virtually the entire surface area of the cooktop 15 is taken up by heating elements 16, 17, 18 which are indicated by dash-dotted lines in FIG. 1. In FIG. 1 the heating elements 16, 17 are two separate cooking zone heating elements of different sizes, while the heating element 18 is a large-area heating element provided between the two cooking zone heating elements 16,17 and virtually surrounds said cooking zone heating elements 16, 17.

In the exemplary embodiment shown, the heating elements 16, 17, 18 are implemented as radiant heating elements which are covered by a glass ceramic panel 19. The glass ceramic panel 19 is also fitted with mounting holes (not shown) through which sockets for mounting supports 20 for oven shelves 21 project, as also shown in FIG. 3.

FIG. 3 is a schematic and not-to-scale front view of a built-in high-level cooking appliance in the open state with the base door 7 resting on the countertop 8. The closed state is indicated by a dashed line.

In this embodiment, two up/down switch panels 25 are located on the front of the fixed housing 1. Each up/down switch panel 25 comprises two pushbuttons, namely an upper CLOSE button 25a for moving the base door 7 in the closing direction and a lower OPEN button 25b for moving the base door 7 in the opening direction. Unless automatic mode (see below) is selected, the base door 7 is moved up, if this is possible, only if the CLOSE buttons 25a of both up/down switch panels 25 are continuously pressed simultaneously; the base door 7 is lowered, if this is possible, only if the OPEN buttons 25a of both up/down switch panels 25 are continuously pressed simultaneously (manual mode). Since in manual mode the person operating the appliance exercises greater attention and is also using both hands in this case, anti-trap protection is then optional.

In this example the control circuit 13 comprises a memory unit 27 for storing at least one target or more specifically travel position P0, P1, P2, PZ of the base door 7, preferably using volatile memory devices, e.g. DRAMs. When a target position P0, P1, P2, PZ has been stored, the base door can be automatically moved in the direction set by actuating one of the buttons 25a, 25b of the up/down switch panels 25 until the next target position has been reached or one of the buttons 25a, 25b is actuated again (automatic mode). In this example the lowest target position PZ corresponds to maximum opening, the (zero) position P0 to the closed state, and P1 and P2 are freely selectable intermediate positions. If the last target position for one direction is reached, further travel must take place in manual mode if this is possible (i.e. if the last end positions do not correspond to the fully open or the closed end state). Similarly, if no target position has been stored for a direction—which would be the case, for example, for raising the door to the closed position if only PZ is stored but not P0, P1, P2—movement in this direction must take place in manual mode. If no target position has been stored, e.g. at initial installation or after a power outage, automatic operation is not possible. If the base door 7 is moved in automatic mode, anti-trap protection is preferably activated.

A target position P0, P1, P2, PZ can be any position of the base door 7 between and including the zero position P0 and the maximum open position PZ. However, the maximum open position PZ stored need not be the position resting on the countertop 8.

The drive motor 9 from FIG. 1 has at least one sensor unit 31, 32 disposed on a motor shaft 30, possibly upstream or downstream of a gear, in order to measure a travel distance and a position and/or a speed of the base door 7. The sensor unit can comprise, for example, one or more induction, Hall effect, optical, SAW sensors, etc. Here, for simple travel and speed measurement, two Hall effect (sub-)elements 31 offset by 180°—i.e. opposite one another—are mounted to the motor shaft 30, and a Hall effect sensor 32 is mounted at a fixed distance from this region of the motor shaft. If a Hall element 31 then passes the sensor 32 during rotation of the motor shaft 30, a measurement signal or more specifically a sensor signal is produced which is digital to a good approximation. With (not necessarily) two Hall elements 31, two signals are produced for one revolution of the motor shaft 30. By means of time domain analysis of these signals, e.g. their time difference, the velocity vL of the base door 7 can be determined, e.g. via comparison tables or real-time conversion in the control circuit 13. An absolute distance traveled and an absolute position of the base door 7 can be determined by, respectively, addition and subtraction of the measurement signals.

A speed control loop can implement the velocity e.g. via a PWM-controlled power semiconductor.

For zero point determination, the travel measurement is automatically re-calibrated to the zero position P0 of the base door 7 at each startup so that e.g. an incorrectly transmitted or received sensor signal is not passed on.

Zero point determination can be established in different ways. The use of switches 24 alone is not optimal because of their comparatively high switching point tolerances.

In this embodiment, two switches 24 are mounted to a support 34 (indicated by a dash-dotted line) of the body 33 such that they are actuated by the upward moving lift mechanism 10 when closing the base door 7 if the base door 7 undershoots a predetermined gap dimension dend between base door 7 and muffle opening, the switches 24 being located above the muffle 5 on the body 33 at a distance from the walls of the muffle 5 for cooling reasons. The mechanical actuation of the switches 24 (see curved arrows) by the lift mechanism 10—which is represented here purely schematically by a dotted line in an almost closed position prior to actuation, the straight arrows indicating the associated movement direction—has the advantage e.g. over direct actuation by the base door 7 that switching is unimpaired by tilting or positional inaccuracy of the base door 7. In addition, expensive thermal insulation of the switches which would otherwise be necessary e.g. in the case of switching by the base door or more specifically the cooktop constituting the top surface of the base door can be dispensed with.

When actuated, the switches 24 can also deactivate anti-trapping protection.

The predetermined gap dimension dend is here between 12 and 4 mm, preferably between 6 and 10 mm. The switches are duplicated here for safety reasons; however, e.g. for cost-saving reasons, a single switch can be provided, for example.

It is more reliable to determine the zero point by using the travel distance measurement. If it is typically established that the travel distance is zero, i.e. the zero position P0 is deemed to have been reached, the base door 7 is stopped. Although the travel distance can be determined, for example, by also counting the sensor pulses, an erroneous pulse count may occur which will be passed on unless further action is taken.

Another method is to establish whether or not the base door still moves notwithstanding the activation of the motor 9. In this case, however, trapping in the near region of the base door causing it to stop may simulate an erroneous zero point position.

In this embodiment, therefore, the zero point of the base door 7 is determined by a combination of these methods. To ensure that the control circuit 13 detects the zero point position P0 as such and, on this basis, controls the movement of the base door 7 for a subsequent opening process, first the two switches 24 must be operated and second the travel distance—possibly within a defined tolerance range—as corresponding to the zero position must be measured and/or the motor 9 must no longer be movable, e.g. rotatable, on closing the base door 7. In this embodiment it is even necessary for all three conditions to be fulfilled.

If this is the case, the control circuit 13 initializes the zero point position and resets e.g. the sensor pulse count to zero or to another predetermined value for the zero position P0.

If only one or two conditions occur, an error message can be produced and if necessary the base door 7 reversed. For example, an error message can be issued if the sensor pulse count indicates a zero position P0, but the switches 24 have not yet been actuated, or the motor moves beyond the tolerance range (e.g. 1 to 4 sensor pulses, corresponding to half a revolution up to two revolutions of the motor shaft or of a gear shaft).

The arrangement and division of the control circuit 13 is flexible and unrestricted here, and can therefore also incorporate, e.g. a display board, a control board and a lift board which are physically separate.

### LIST OF REFERENCE SIGNS

1 Housing
2 Wall
3 Cooking chamber
4 Viewing window
5 Muffle
6 Muffle opening
7 Base door
8 Countertop
9 Drive motor
10 Lifting element
11 Control element
12 Operator panel
13 Control circuit
14 Display
15 Cooktop
16 Cooking zone heating element
17 Cooking zone heating element
18 Large-area heating element
19 Glass ceramic panel
20 Support
21 Shelf
22 Upper telescopic bar section
23 Upper telescopic bar section
24 Zero point switch
25 Up/down switch panel
25a Up-switch
25b Down-switch
27 Memory unit
29 Master switch
30 Motor shaft
31 Hall element
32 Sensor
33 Body
34 Support
dend End zone gap
P0 Zero position
P1 Intermediate position
P2 Intermediate position
PZ End position

1-13. (canceled)

14. A cooking appliance, in particular a built-in high-level cooking appliance, comprising at least one muffle defining a cooking chamber and having a muffle opening formed therein, a door for closing the muffle opening, a lift mechanism for lifting and guiding the door and at least one switch in operative communication with the lift mechanism, the at least one switch being actuable depending on a position of the door.

15. The cooking appliance according to claim 14 wherein the switch is disposed above the muffle.

16. The cooking appliance according to claim 14 wherein the switch is disposed above the lift mechanism.

17. The cooking appliance according to claim 14 wherein the lift mechanism includes a telescopic rail.

18. The cooking appliance according to claim 14 wherein the switch is actuated when the lift mechanism has reached a position corresponding to the closed zero position of the door.

19. The cooking appliance according to claim 14 wherein the switch operates when the lift mechanism has reached a position corresponding to a predetermined distance of the door from the closed zero position.

20. The cooking appliance according to claim 14 wherein the at least one switch includes two switches.

21. The cooking appliance according to claim 14 wherein operation of the switch is a necessary but insufficient condition for ascertaining a closed zero position of the door.

22. The cooking appliance according to claim 21 wherein the control device is configured for determining a zero position when the at least one switch is actuated simultaneously with a measurement of the travel distance of the door indicating attainment of the zero position at least within a defined tolerance range.

23. The cooking appliance according to claim 14 wherein the control device is configured for determining a zero position when the at least one switch is actuated simultaneously with a condition occurring wherein the door cannot be moved further with the drive device activated.

24. The cooking appliance according claim 14 wherein the cooking appliance is a built-in high-level cooking appliance having a bottom muffle opening and a base door.

25. A method for determining a zero position of a door of a cooking appliance, comprising the steps of:
providing a built-in high-level cooking appliance, having at least one muffle defining a cooking chamber and having a muffle opening formed therein, a door for closing the muffle opening, a lift mechanism for lifting and guiding the door and at least one switch in operative communication with the lift mechanism, the at least one switch being actuable depending on a position of the door;
determining the zero position of the door when, simultaneously (a) the at least one switch has been actuated and at least one of (b1) it has been measured that a travel distance of the door corresponds to the zero position at least within a tolerance range and (b2) the door cannot be moved further with the drive device activated.

26. The method according to claim 25 wherein the step of determining the zero position includes determining at least when condition (a) occurs and at least one of the other conditions (b1, b1) used for determining the zero position does not occur, or when condition (a) does not occur, but all the other conditions (b1, b1) used for determining the zero position do occur then a fault is ascertained.
